(19) United States
(12) Patent Application Publication
(10) Pub. No.: US 2010/0145686 A1
(43) Pub. Date: Jun. 10, 2010

(54) INFORMATION PROCESSING APPARATUS CONVERTING VISUALLY-GENERATED INFORMATION INTO AURAL INFORMATION, AND INFORMATION PROCESSING METHOD THEREOF

(75) Inventor: Shinichi HONDA, Kanagawa (JP)

Correspondence Address: GIBSON & DERNIER LLP, 900 ROUTE 9 NORTH, SUITE 504, WOODBRIDGE, NJ, 07095, US

(73) Assignee: Sony Computer Entertainment Inc., Tokyo (JP)

(21) Appl. No.: 12/621,576

(22) Filed: Nov. 19, 2009

(30) Foreign Application Priority Data
Dec. 4, 2008 (JP) 2008-310224

(51) Int. Cl. G10L 21/00; G10L 13/00

(52) U.S. Cl. 704/205; 704/260; 704/E21.001

(57) ABSTRACT

In an information processing apparatus, the information of a webpage acquired by a page information reception unit is analyzed for a tag and the like by a page information analysis unit, and a character string is extracted under an extraction condition that is set in advance. Multiple character string groups are extracted so that multiple character strings are concurrently perceived in an aural manner. The extracted character strings are converted into respective audio signals by a text-to-sound conversion unit. The multiple audio signals thus generated are processed and synthesized by an audio processing unit based on the allocation pattern set by a frequency band allocation unit, the localization set by a localization allocation unit, and the difference in time at which the audio signals are output set by a time allocation unit. The output unit outputs the synthesized sounds.

### BACKGROUND OF THE INVENTION

1. Field of the Invention

The present invention relates to an information processing technique and particularly to an information processing apparatus that converts visually-generated information into aural information and to an information processing method utilized in the information processing apparatus.

2. Description of the Related Art

When people with visual impairments such as blindness or people with poor eyesight try to acquire information by using information terminals such as personal computers to access, for example, websites, the information displayed on display apparatuses needs to be converted so as to be decipher through a non-visual means. Regarding this, apparatuses that convert the character information that is displayed into audio or Braille have been realized in the past (for example, see Japanese Paten Laid Open Publication 2004-226743). These apparatuses classify described character strings on the basis that information displayed via the Internet, etc., is described in a markup language such as HTML or XML. The apparatuses are designed, based on the order of character strings for aural perception, to extract character strings described after a <title> tag, a <head> tag, etc., and to convert the character strings into voice to be aurally perceived when a user wants to know whole headline of a certain web page.

When converting character information on a website screen, etc. into audio information for outputting, the efficiency is always considered to be as an issue. Reading headlines and the like ahead of time based on the tags and performing narrowing them down as described above are both time-consuming. This is due to the fact that, whereas visual information can be looked over in one time, aural information needs to be perceived, step by step, in the order of the whole text. Even when a character string having a predetermined attribute is read ahead based on tags, a user is still required to repeat the operations of going back and forth with respect to the character string so as to obtain the target information.

### Related Art List

JPA laid open 2004-226743

### SUMMARY OF THE INVENTION

In this background, a purpose of the present invention is to provide a technique for aurally perceiving visual information with high efficiency.

One embodiment of the present invention relates to an information processing apparatus. The information processing apparatus comprising: an information analysis unit operative to extract a plurality of character strings from character information under a predetermined condition; a text-to-sound conversion unit operative to convert a plurality of character strings extracted by the information analysis unit into respective audio signals; a frequency band allocation unit operative to allocate frequency bands to the plurality of respective audio signals converted by the text-to-sound conversion unit in a different pattern; an audio processing unit operative to extract and then synthesize an allocated frequency band component individually from the plurality of audio signals in the pattern of a frequency band allocated by the frequency band allocation unit; and an output unit operative to output the audio signal synthesized by the audio processing unit as audio.

The term “pattern” is used to imply a variation in both width and a frequency band of bands to be allocated and bands not to be allocated in an audible frequency band. There may be multiple regions to be allocated or multiple regions not to be allocated in the audible frequency band.

Another embodiment of the present invention relates to an information processing method. The information processing method comprising: extracting a plurality of character strings from character information under a predetermined condition; converting a plurality of character strings into respective audio signals; allocating frequency bands each to the plurality of respective audio signals in a different pattern; extracting and synthesizing an allocated frequency band component from each of the plurality of audio signals in the pattern of an allocated frequency band; and outputting a synthesized audio signal as audio.

Optional combinations of the aforementioned constituting elements, and implementations of the invention in the form of methods, apparatuses, systems, and computer programs may also be practiced as additional modes of the present invention.

### BRIEF DESCRIPTION OF DRAWINGS

Embodiments will now be described, by way of example only, with reference to the accompanying drawings that are meant to be exemplary, not limiting, and wherein like elements are numbered alike in several figures, in which:

FIG. 1 is a diagram showing the configuration of an information processing apparatus according to the embodiment;

FIG. 2 is a diagram explaining the allocation of frequency bands in the embodiment;

FIG. 3 is a diagram showing the detailed configuration of an audio processing unit in the embodiment;

FIG. 4 is a diagram showing the detailed configuration of a first frequency band extraction unit in the embodiment;

FIG. 5 is a diagram schematically showing the pattern of how blocks are allocated in the embodiment;

FIG. 6 is a diagram showing an example of an importance determination table stored in an allocation information memory unit in the embodiment;

FIG. 7 is a diagram showing a setting example related to an extraction condition and the condition of the read-out, both in regard to a character string, in the embodiment;

FIG. 8 is a diagram showing a setting example related to an extraction condition and the condition of the read-out, both in regard to a character string, in the embodiment;

FIG. 9 is a flowchart showing the sequence of processing of an information processing apparatus reading out the information of a webpage with multiple sounds.

### DETAILED DESCRIPTION OF THE INVENTION

The invention will now be described by reference to the preferred embodiments. This does not intend to limit the scope of the present invention, but to exemplify the invention.

First, the final output mode achieved in the embodiment is generally described. The information processing apparatus according to the embodiment converts character information such as that on a webpage into an audio signal and outputs the audio signal (such a process is also referred to as “to read out,” hereinafter). In general, it is difficult to aurally perceive multiple streams of information concurrently. Thus, character strings are basically read out in order when a conventional text-to-sound converter is used. Efforts are made, for example, by changing the order in accordance with information such as tags. However, regardless of such efforts, sounds need to be sequentially perceived, and obtaining the desired information is thus time consuming.

Contrarily, the contents of character information can be perceived with high efficiency by concurrently reading out multiple information in the embodiment. A technique for segregating multiple sounds so as to be perceived is important in this case. Allocating different frequency bands to multiple sounds and then extracting and synthesizing only the allocated frequency components allow the multiple sounds to be concurrently perceived. A detailed description will follow. Alternatively, multiple sounds are localized in different directions. Various variations can be further introduced when multiple sounds can be concurrently perceived by using such means.

For example, one possible option is to start reading out character strings, at slightly different times, that will be concurrently read out. Reading out the strings at slightly different time will possibly allow for further segregation of sounds so that they will be perceived. A headline and a subhead can be distinguished from each other by starting to read out the headline at a given time followed by starting to read out the subhead while the headline is still being read out. Furthermore, whether character strings enclosed within the same tags are to be concurrently read out or whether character strings, such as a headline and a subhead, having different attributes are to be read out can be changed. Concurrently reading out multiple character strings at points in time by using localization allocation and frequency band allocation, all selected from the above-stated variations by a user, allows for much quicker perception of the contents of an entire page or acquisition of desired information compared to the read-out by using a conventional method.

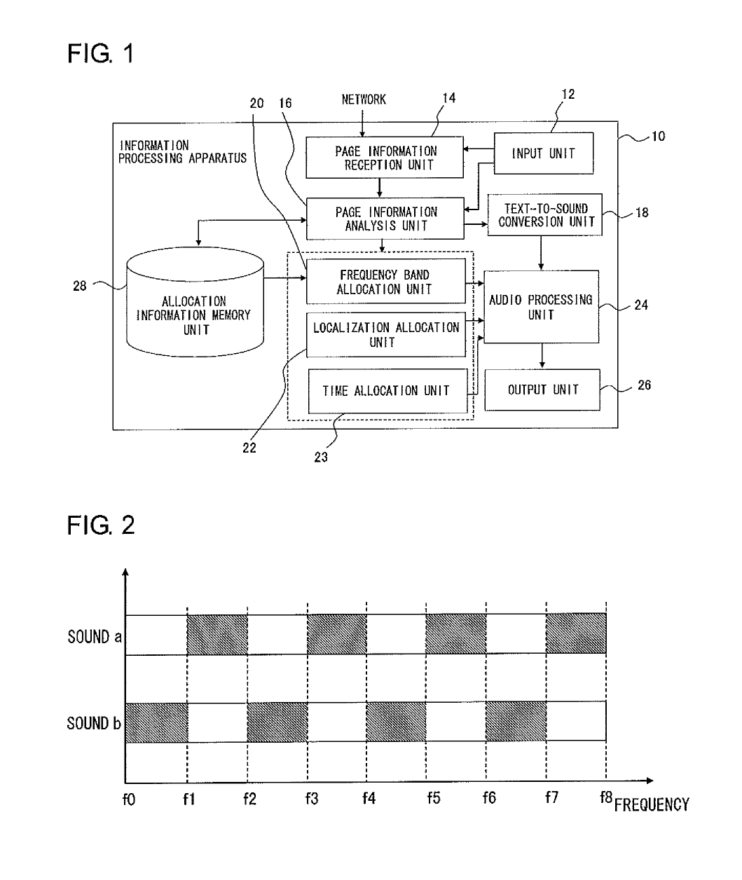

FIG. 1 shows the configuration of an information processing apparatus according to the embodiment. An information processing apparatus 10 includes: an input unit 12 that receives an input from a user; a page information reception unit 14 that acquires the page information of a website (hereinafter, also referred to as a “webpage”) from a connected network; a page information analysis unit 16 that extracts, by analyzing the page information, a character string to be read out; a frequency band allocation unit 20, a localization allocation unit 22, and a time allocation unit 23 that allocates a frequency band, localization, and a time to the character string to be read out, respectively; a text-to-sound conversion unit 18 that converts the character string to be read out into an audio signal; an audio processing unit 24 that performs a process on the audio signal of each character string based on an allocation result; an output unit 26 that outputs, as audio, the audio signal on which the process is performed; and an allocation information memory unit 28 that stores an extraction condition for the character string and information necessary for an audio processing.

In FIG. 1, the elements shown in functional blocks that indicate a variety of processes are implemented in hardware by any CPU (Central Processing Unit), memory, or other LSI's, and in software by a program loaded in memory, etc. Therefore, it will be obvious to those skilled in the art that the functional blocks may be implemented in a variety of manners by a combination of hardware and software.

In the following example, a detailed explanation will be given of an embodiment in which a webpage is acquired from a website that has been accessed via a network and the character information included therein is then converted into an audio signal. Information to be acquired is not limited to a webpage. Any data that is described in a markup language such as a document file applies in a similar manner.

The input unit 12 is any of a keyboard, a button, or the like, or the combination thereof and for inputting, for example, the setting of each parameter or the selection of a webpage. A general text-to-sound converter is provided with a direction instruction key for going back and forth in search for a character string to be read out from the information of a page. The input unit 12 may have a similar feature.

The page information reception unit 14 receives the information of a webpage from a network upon a request from a user through the input unit 12. The sequence of processes performed by the page information reception unit 14, such as connecting to a network and accessing a website, may be the same as that of a general information processing apparatus. The page information analysis unit 16 analyzes the information of a webpage received by the page information reception unit 14 based on an extraction condition determined by, for example, the user's selection. Basically, a character string enclosed within a tag that satisfies a condition set by a user is extracted to be read out. A detailed description of a specific example will follow. The page information analysis unit 16 further acquires information indicating the type of an audio process to be performed on each of the audio signals to be concurrently read out and inputs the information to the frequency band allocation unit 20, the localization allocation unit 22, and the time allocation unit 23.

The frequency band allocation unit 20 sets a pattern of a frequency band to be allocated to each character string to be read out. Multiple patterns of a frequency bands to be allocated are stored in the allocation information memory unit 28 in advance, and the pattern for each sound is determined based on the information obtained from the page information analysis unit 16. The localization allocation unit 22 sets the direction for localizing character strings to be concurrently read out based on the information obtained from the page information analysis unit 16. The time allocation unit 23 sets a time in a relative manner for reading out the character string to be read out based on the information obtained from the page information analysis unit 16.

The text-to-sound conversion unit 18 converts the character string to be read out into an audio signal. This process is similar to that performed by a conventional text-to-sound converter. Thus, the text-to-sound conversion unit 18 may have a similar configuration and perform similar processing sequence. In accordance with at least any one of the settings of the frequency band allocation unit 20, the localization allocation unit 22, and the time allocation unit 23, the audio processing unit 24 performs the audio processing of multiple audio signals converted by the text-to-sound conversion unit 18 and then synthesizes the resultant. The output unit 26 may be configured with an audio output apparatus, such as built-in speakers, externally-connected speakers, or earphones, used for a general electronic devices and outputs as audio an audio signal synthesized by the audio processing unit 24.

A detailed description will be made regarding how a frequency band is allocated by the frequency band allocation unit 20. A human being recognizes a sound by two stages: the detection of the sound by ears; and the analysis of the sound by the brain. For a human being to tell one sound from another, both produced concurrently from different sound sources, the acquisition of information, that is, segregation information is necessary that indicates that the sound sources are different in either of the two stages or in both of the two stages. For example, hearing different sounds with the right ear and the left ear means obtaining segregation information at the inner ear level, and the sounds are analyzed and recognized as different sounds by the brain. Sounds that are already mixed can be segregated at a brain level by checking the difference in a sound stream or tone quality against segregation information learned or memorized during one's lifetime and performing an analysis.

When hearing multiple sounds in a mixture through a pair of speakers, earphones, or the like, no segregation information can be obtained at the inner ear level, and the sounds are thus recognized as different sounds by the brain based on the differences in a sound stream or tone quality as described above. However, only a limited number of sounds can be distinguished in this manner. Thus, in order to generate an audio signal that can be eventually recognized by segregation even when the audio signal is mixed with another signal, frequency bands are allocated respectively to multiple sound sources and segregation information that works on the inner earn is artificially added to an audio signal. In addition, the audio signal is localized in a different direction to help the perception of the auditory stream of each sound.

FIG. 2 is a diagram explaining the allocation of frequency bands. The horizontal axis of the figure represents frequencies, and frequencies f0-f8 are set to be an audible band. The figure shows the situation where two audio sounds, sound a and sound b, are heard while both are mixed. In the embodiment, an audible band is divided into multiple blocks, and each block is allocated to at least any one of multiple audio signals. Then only a frequency component, which belongs to the allocated block, is extracted from each audio signal.

In FIG. 2, the audible band is divided into eight blocks at the frequencies f1-f7. For example, as shown by shaded areas, four blocks that are between the frequency f1 and the frequency f2, the frequency f3 and the frequency f4, the frequency f5 and the frequency f6, and the frequency f7 and the frequency f8 are allocated to the sound a, and four blocks that are between the frequency f0 and the frequency f1, the frequency f2 and the frequency f3, the frequency f4 and the frequency f5, and the frequency f6 and the frequency f7 are allocated to the sound b. For example, by setting the frequencies f1-f7, which are boundary frequencies of the blocks, to, for example, the boundary frequencies of some of twenty-four critical bands based on the Bark scale, the effect of dividing frequency bands can be enhanced.

A critical band is a frequency band range where the amount of the masking of other sound by a sound having a given frequency band range does not increase even when the frequency band width is further increased. Masking is a phenomenon of a threshold of hearing for a given sound increasing in the presence of other sound, in other words, a phenomenon of the sound becoming difficult to be perceived. The amount of masking is the amount of increase in the threshold of hearing. More specifically, those sounds that have different critical bands are difficult to be masked by one another. An adverse effect, for example, the masking of the frequency component of the sound b that belongs to the blocks of the frequencies f2-f3 by the frequency component of the sound a that belongs to the blocks of the frequencies f1-f2 can be controlled by dividing the frequency band by using the twenty-four critical bands of Bark's scale determined by an experiment. The same applies to other blocks, and as a result, the sound a and the sound b are identified as audio signals that barely cancel each other out.

The division into blocks may not depend on the critical bands. In any case, a reduction in frequency bands that overlap allows segregation information to be provided by using frequency resolution in the inner ear. The example shown in FIG. 2 illustrates blocks having almost the same band width; however, the band width may be changed in accordance with a frequency band in reality. For example, there may be a band range with two critical bands as one block and a band range with four critical bands as one block. How the division into blocks is conducted may be determined, for example, in consideration of general characteristics of a sound, such as consideration that a sound having a low frequency is difficult to be masked. The example shown in FIG. 2 illustrates a series of blocks being alternately allocated to the sound a and the sound b. However, the way of allocating the blocks is not limited to this, and, for example, two consecutive blocks may be allocated to the sound a.

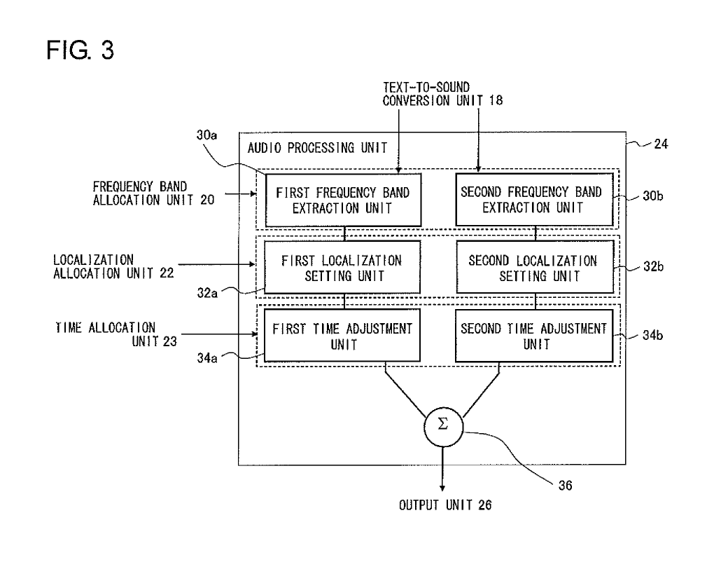

FIG. 3 shows the detailed configuration of an audio processing unit 24. The audio processing unit 24 includes a first frequency band extraction unit 30a, a second frequency band extraction unit 30b, a first localization setting unit 32a, a second localization setting unit 32b, a first time adjustment unit 34a, a second time adjustment unit 34b, and a synthesizing unit 36. The figure shows an example when the number of character strings to be concurrently read out is set to two, and two audio signals generated by converting the two character strings into sounds are input from the text-to-sound conversion unit 18. The first frequency band extraction unit 30a, the first localization setting unit 32a, and the first time adjustment unit 34a sequentially process one of the two audio signals. The second frequency band extraction unit 30b, the second localization setting unit 32b, and the second time adjustment unit 34b sequentially process the other one of the audio signals.

The first frequency band extraction unit 30a and the second frequency band extraction unit 30b each extract, from the respective audio signals, the respective frequency components allocated to each of the audio signals. The block information of the frequency band allocated to each of the sounds, in other words, the allocation pattern information is set to the first frequency band extraction unit 30a and the second frequency band extraction unit 30b by the frequency band allocation unit 20. The first localization setting unit 32a and the second localization setting unit 32b localize the audio signals in respective directions allocated to the audio signals. The direction for the localization allocated to each of the audio signals are set to the first localization setting unit 32a and the second localization setting unit 32b by the localization allocation unit 22. The first localization setting unit 32a and the second localization setting unit 32b can be realized by, for example, pan-pots.

The first time adjustment unit 34a and the second time adjustment unit 34b delay the time at which the read out of either one of the audio signals is started with respect to the time at which that of the other audio signal is started. The time at which the read out of each of the audio signals is started in consideration of the delay time is set to the first time adjustment unit 34a and the second time adjustment unit 34b by the time allocation unit 23. Alternatively, the delay time is set to the adjustment unit for which the audio signal is delayed. The first time adjustment unit 34a and the second time adjustment unit 34b can be realized by, for example, a timing circuit or a delay circuit.

Audio signals output by the first time adjustment unit 34a and the second time adjustment unit 34b are synthesized and then output by the synthesizing unit 36. Not all the first frequency band extraction unit 30a, the first localization setting unit 32a, and the first time adjustment unit 34a need to operate, and any one of a frequency extraction process, a localization process, and a time-adjusting process alone, or any combination of the processes may be performed. The same applies to the second frequency band extraction unit 30b, the second localization setting unit 32b, and the second time adjustment unit 34b. The type of the process to be performed is included in the information that is set in advance with regard to read-out condition and is acquired by the page information analysis unit 16.

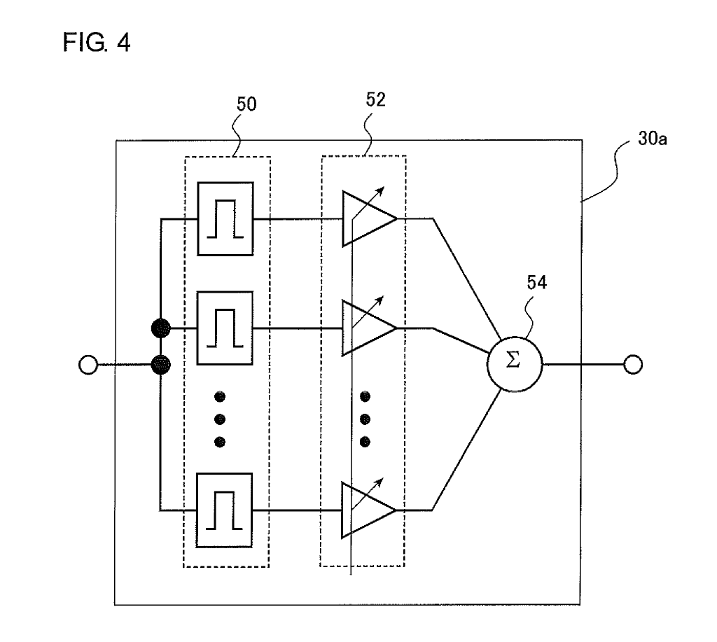

FIG. 4 shows the detailed configuration of the first frequency band extraction unit 30a. The second frequency band extraction unit 30b may have a similar configuration, and the configuration can be applied just by changing the allocation pattern of a frequency band. The first frequency band extraction unit 30a includes a filter bank 50, an amplitude adjusting unit 52, and a synthesizing unit 54. The filter bank 50 segregates the entered audio signal into blocks (eight blocks in the example of FIG. 2) of a frequency band as shown in FIG. 2. When segregating into N-number of blocks, the filter bank 50 is constituted with N-number of band-pass filters. To each band-pass filter, extracted frequency-band information for each block is set in advance.

The amplitude adjusting unit 52 sets the audio signal of each block that is output by each band-pass filter of the filter bank 50 to an amplitude that is set in advance. In other words, the amplitude is set to zero for a frequency band block that is not allocated, and the amplitude is set to be as it is for a frequency band block that is allocated. The synthesizing unit 54 synthesizes and then outputs the audio signal of each block for which amplitude adjustment is performed. Such a configuration allows for the acquisition of audio signals obtained by extracting frequency band components, each one allocated to each of the audio signals. The frequency band allocation unit 20 inputs N-bit selection/non-selection information for the N-number of blocks in accordance with an allocation pattern, and each of N-number of amplitude adjustment circuits of the amplitude adjusting unit 52 needs to make an adjustment by referring to corresponding bit information so that the amplitude is set to 0 by a non-selected amplitude adjustment circuit.

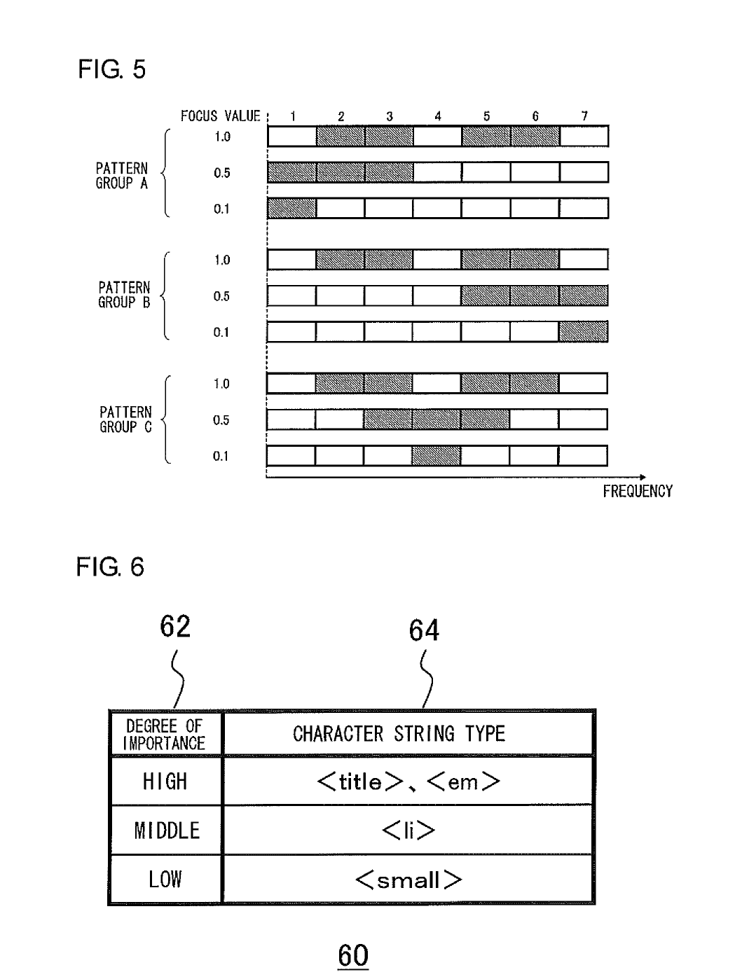

A detailed description will be made regarding how a frequency band is allocated by the frequency band allocation unit 20. In FIG. 2, frequency-band blocks are equally allocated to the “sound a” and the “sound b” for the explanation of a method for segregating and then recognizing multiple sound signals. On the other hand, the perceptibility of each of the sounds to be concurrently perceived will sound can be adjusted by increasing or decreasing the number of blocks to be allocated. FIG. 5 schematically shows an example of the pattern of how blocks are allocated.

The figure shows an audible band divided into seven blocks. As in FIG. 2, the horizontal axis represents frequencies, and blocks are denoted as block 1, block 2, . . . , block 7 staring from the side with a low band for the purpose of explanation. First, an attention is given to three allocation patterns from the top described as a “pattern group A.” Among these patterns, the pattern at the top has the largest number of allocated blocks and thus provides the most perceptibility. A pattern on a lower level has less number of allocated blocks and thus provides a reduced perceptibility. The degree of the sound perception determined by the number of allocated blocks is referred to as the “focus value.” The figure illustrates a value provided as the focus value to the left of each allocation pattern.

When the degree of the perceptibility of a given audio signal needs to be at the maximum level, that is, when the audio signal needs to be perceived most readily compared to other audio signals, an allocation pattern having a focus value of 1.0 is applied to the audio signal. In the “pattern group A” of the figure, four blocks: a block 2; a block 3; a block 5; and a block 6, are allocated to the same audio signal.

When slightly reducing the degree of the perceptibility of the same audio signal, the allocation pattern is changed to an allocation pattern of, for example, a focus value of 0.5. In the “pattern group A” of the figure, three blocks: the block 1; the block 2; and the block 3, are allocated. Similarly, when the degree of the perceptibility of the same audio signal needs to be at the minimum, that is, when the audio signal needs to be perceived in the least noticeable manner, the allocation pattern is changed to an allocation pattern of, for example, a focus value of 0.1. In the “pattern group A” of the figure, one block, which is the block 1, is allocated. As described later in the embodiment, the degree of importance is set in accordance with a character string to be read out, the focus value is changed when audio signals with different degree of importance are concurrently read out.

As shown in the figure, it is ensured that not all the blocks are allocated even to an audio signal showing the highest intensity with a focus value of 1.0, preferably. In the figure, the block 1, the block 4, and the block 7 are not allocated. This is because of the possibility that, for example, when the block 1 is also allocated to an audio signal of a focus value of 1.0, the frequency component of other audio signal of a focus value of 0.1 to which only the block 1 is allocated is masked. In the embodiment, it is preferable that an audio signal with a low focus value can be perceived while segregating multiple audio signals so as to be perceived. Therefore, it is ensured that a block allocated to an audio signal with a low focus value is not allocated to an audio signal with a high focus value.

The above explanation is made based on the “pattern group A.” However, there are various allocation patterns even for the same focus value as shown in the “pattern group B” and the “pattern group C.” Therefore, selecting a different pattern group even with the same focus value prevents the audio signals to be cancelled out by each other. Upon the receipt of a request from the page information analysis unit 16 for setting the same focus values to audio signals to be concurrently perceived, the frequency band allocation unit 20 determines an allocation pattern by selecting, from multiple pattern groups stored in the allocation information memory unit 28, a different pattern group for each of the audio signals.

An allocation pattern that is stored in the allocation information memory unit 28 may include that for focus values of other than 0.1, 0.5, or 1.0. The number of blocks, however, is limited, and allocation patterns that can be prepared in advance are thus limited. Thus, in the case of a focus value that is not stored in the allocation information memory unit 28, an allocation pattern is determined by interpolating the allocation patterns having near focus values and stored in the allocation information memory unit 28. As a method of interpolating, a frequency band to be allocated is adjusted by further dividing a block, or the amplitude of a frequency component that belongs to a given block is adjusted.

A detailed description will be made regarding the sequence of the page information analysis unit 16 determining a character string to be concurrently read out. FIG. 6 shows an example of an importance determination table, which is stored in an allocation information memory unit 28, referred to by the page information analysis unit 16. An importance determination table 60 includes a degree-of-importance column 62 and a character-string-type column 64. As the information described in the character-string-type column 64 in the figure, tags are shown that are used in a markup language such as HTML. For example, a character string enclosed with a “<title>” tag represents the title of a page, and a character string enclosed with an “<em>” tag represents an emphasized character, both with the degree of importance set to “high” in the degree-of-importance column 62. A character string enclosed with an “<li>” tag represents an item in a list, and the degree of importance is set to “middle.” A character string enclosed with a “<small>” tag represents a small character, and the degree of importance is set to “low.”

As described above, by referring to the importance determination table 60 storing tags in relation with the degree of importance, the page information analysis unit 16 can extract, in accordance with, for example, a request from a user, only a character string with a “high” degree of importance and determine the character string to be read out. Alternatively, a character strings with a “high” degree of importance and a character string with a “middle” degree of importance are extracted to be read out, and a request is transmitted to the frequency band allocation unit 20 so that the focus value of the former character string is set to be large and the focus value of the latter character string is set to be small. In this way, a character string to be read out can be extracted based on not only the tag but also the degree of importance. With regard to the setting, a general setting may be selected in advance by the manufacturer of the apparatus or the setting may be customized by a user.

The type of a character string set in the character-string-type column 64 is not limited to tags. The type of a character string may be a fixed phrase or a specific word. In this case, the page information analysis unit 16 may perform morphological analysis on, for example, an HTML document to be processed so that a character string is extracted that is in a predetermined range where a corresponding sentence or word is included. Alternatively, the user's preference may be learned by storing, in the column for a “high” degree of importance in the importance determination table 60 with, a character string that has been entered with a frequency larger than a predetermined threshold value as a past search word from a user in the information processing apparatus 10.

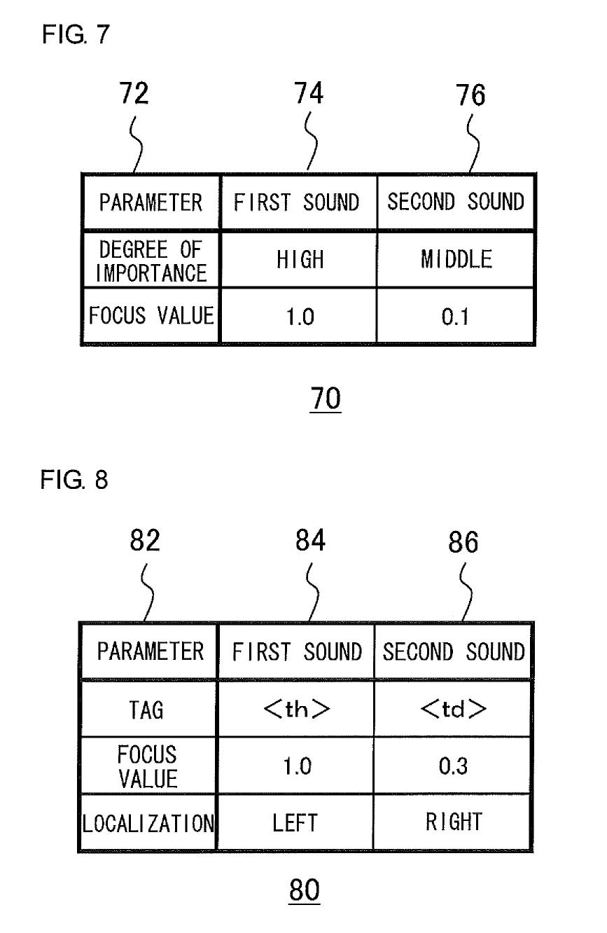

Alternatively, regardless of the degree of importance, the page information analysis unit 16 may extract a character string enclosed with a specific tag, depending on the setting. As previously described, extracting the character string to be read out by using the degree of importance or a tag and setting the focus value, localization, and delay time to each of the character strings to be concurrently read out allow the number of variations of the read-out order or the combination thereof to be dramatically increased. With this, a user can select the most appropriate mode from assorted variations in accordance with the user's purpose or preference. FIGS. 7 and 8 show setting examples related to an extraction condition and the condition of the read-out. The parameter-setting tables are stored in the allocation information memory unit 28 and are used by the page information analysis unit 16 for extracting a character string and for requesting for the setting of a variety of parameters. Multiple such parameter-setting tables may be prepared in advance so that a user can make a selection.

As shown in the parameter column 72, a character string is extracted based on the “degree of importance,” and the “focus value” is changed in a parameter-setting table 70 in FIG. 7. Regarding the two sounds that will be concurrently perceived that are described in a first sound column 74 and a second sound column 76, a first sound represents a sound for a character string with a “high” degree of importance, and the focus value thereof is set to “1.0.” A second sound represents a sound for a character string with a “middle” degree of importance, and the focus value thereof is set to “0.1.” With this setting, the page information analysis unit 16 extracts a character string that is found to be one of a “high” degree of importance and a character string that is found to be one of a “middle” degree of importance from the top of a page, and the former character string and the latter character string are read out and concurrently perceived in an audible manner with the voice at a relatively comfortable volume and with the voice at a moderate volume, respectively.

As described above, since allocation is carried out with various frequency band patterns, the sound with a “middle” degree of importance is just enough to be perceived in detail at this time. A user can then check the character string with a “middle” degree of importance while listening to the sound of the character string with a “high” degree of importance at the same time. Thus, the user can perceive the overview of the entire page, which cannot be perceived only with a character string with a “high” degree of importance, without going back to check a part that has been skipped once.

As shown in the parameter column 82, a character string is extracted based on a “tag” and both the “focus value” and the “localization” are changed in a parameter-setting table 80 in FIG. 8. Regarding two sounds described in a first sound column 84 and a second sound column 86, a first sound represents a sound for a character string with a “<th>” tag, and the focus value and the localization thereof are set to “1.0” and “left,” respectively. A second sound represents a sound for a character string with a “<td>” tag, and the focus value and the localization thereof are set to “0.3” and “right,” respectively. With this setting, the page information analysis unit 16 extracts both a character string that is found to be a “table headline” represented by a “<th>” tag and a character string that is found to be “table data” represented by a “<td>” tag, and the former and the latter are concurrently perceived in an audible manner with the voice output from the left side at a relatively comfortable volume and with the voice output from the right side at a moderate volume, respectively.

In this case, in addition to the difference in localization, a frequency band is allocated to each of the sounds and both of the sounds can be perceived in detail. A user can perceive all the data of the table almost at one time, without going back to the part of the data that needs to be checked after listening to all the table headline included in a page. As described above, when the tag of a first sound and the tag of a second sound have a principal-and-accessory relationship, the time allocation unit 23 may adjust the time to start the read-out of a following character string corresponding to the one within a “principle” tag after the completion of the read-out of a character string corresponding to the one within an “accessory” tag so as to prevent only the character strings within principle tags from being read out first.

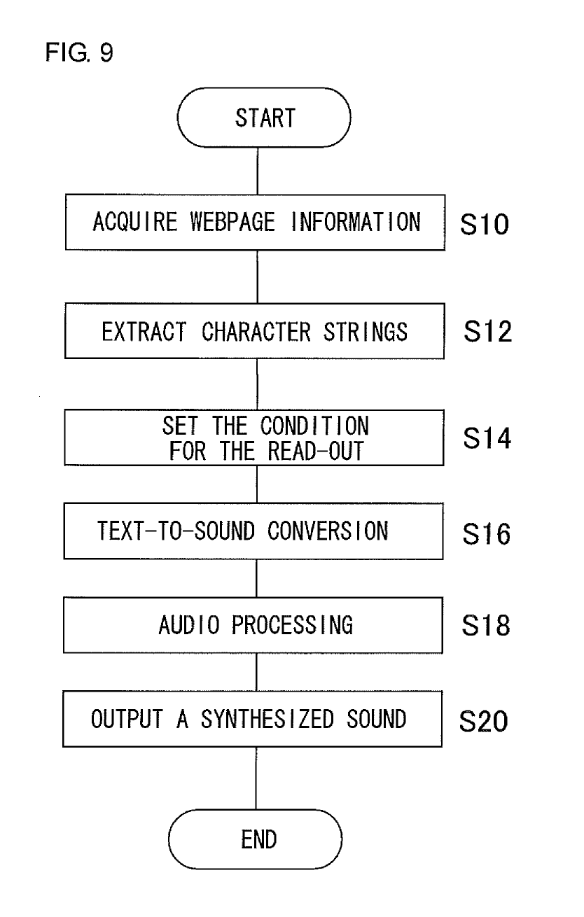

A detailed description will now be made of the operation by the configurations described thus far. FIG. 9 is a flowchart showing the sequence of the processing of the information processing apparatus 10 reading out the information of a webpage with multiple sounds. The page information reception unit 14 acquires the information of a webpage from a desired website via a network by a user entering a request input to the input unit 12. The page information analysis unit 16 then extracts a character string from the webpage after checking the extraction condition in reference to the parameter-setting table of the allocation information memory unit 28 (S12). When the degree of importance is specified by the extraction condition, a character string is extracted after the relationship between a tag and the degree of importance is checked in reference to the importance determination table of the allocation information memory unit 28.

When the page information analysis unit 16 inputs the read-out condition, that is, the information regarding a focus value, the information regarding localization, and the information regarding the delay time, by referring to the parameter-setting table, to the frequency band allocation unit 20, the localization allocation unit 22, and the time allocation unit 23 respectively, the frequency band allocation unit 20, the localization allocation unit 22, and the time allocation unit 23 accordingly retrieve necessary information from the allocation information memory unit 28 and configure the settings for corresponding functional blocks of the audio processing unit 24 (S14).

Meanwhile, the text-to-sound conversion unit 18, having acquired the information regarding a character string to be read out from the page information analysis unit 16, converts the character string into an audio signal in order from the top of a page (S16). The audio processing unit 24 then accordingly performs audio processing such as the extraction of a frequency component, localization, and time delay under the condition set in S14 and synthesizes each audio signal (S18). The output unit 34 then outputs a synthesized sound (S20).

According to the embodiment described above, multiple character strings that satisfy the condition set in advance are extracted and then output as audio signals in parallel in an information processing apparatus that outputs character information such as a webpage as an audio signal. Different frequency band patterns are allocated so that multiple audio signals are aurally perceived in a segregated manner. The same parts of the frequency bands may be allocated as long as at least a part of one frequency band to be allocated is different from that of another frequency band. Furthermore, localizing sounds in different directions or reading out sounds at slightly different times allows the details of both sounds to be perceived even when the sounds are concurrently output. This allows for the rapid aural perception of character information, which has been time-consuming in the past. By changing the condition required for extraction, a read-out condition can be realized that is suitable for various situations such as when an entire page needs to be skimmed through or when a certain part needs to be checked in detail.

The introduction of a concept of the degree of importance for the extraction of a character string allows for an information output that meets more diverse needs. By changing the total band width of a frequency band to be allocated in accordance with the level of the degree of importance, the information with a high degree of importance can be perceived more readily and the information with a low degree of importance can be moderately perceived in an aural manner. Therefore, the impression, indicating whether or not the character is important, that can be projected by the size of a character and the like can be felt intuitively in an aural manner.

Described above is an explanation of the present invention based on the embodiments. The embodiment is intended to be illustrative only and it will be obvious to those skilled in the art that various modifications to constituting elements and processes could be developed and that such modifications are also within the scope of the present invention.

What is claimed is:

1. An information processing apparatus comprising:
an information analysis unit operative to extract a plurality of character strings from character information under a predetermined condition;
a text-to-sound conversion unit operative to convert a plurality of character strings extracted by the information analysis unit into respective audio signals;
a frequency band allocation unit operative to allocate frequency bands to the plurality of respective audio signals converted by the text-to-sound conversion unit in a different pattern;
an audio processing unit operative to extract and then synthesize an allocated frequency band component individually from the plurality of audio signals in the pattern of a frequency band allocated by the frequency band allocation unit; and
an output unit operative to output the audio signal synthesized by the audio processing unit as audio.

2. The information processing apparatus according to claim 1, wherein
the character information is described in a markup language, and
the information analysis unit extracts, in reference to an importance determination table storing a tag in relation with the degree of importance of a character string enclosed within the tag, a character string enclosed within a corresponding tag in accordance with the degree of importance set as the condition.

3. The information processing apparatus according to claim 1, wherein the information analysis unit extracts, in reference to an importance determination table storing a character string set by a user in relation with the degree of importance of the character string, a corresponding character string in accordance with the degree of importance set as the condition.

4. The information processing apparatus according to claim 1, wherein the information analysis unit extracts, in reference to an importance determination table storing, as a character string with a high degree of importance, the character string of a search key that has been entered in the information processing apparatus with a frequency larger than a predetermined threshold value from a user when conducting a past information search, a character string included in a predetermined range where the search key described in the importance determination table is included when the extraction condition for a character string specifies the degree of importance of the character string to be high.

5. The information processing apparatus according to claim 2, wherein a frequency band allocation unit adjusts, in accordance with the degree of importance determined as the condition, the total bandwidth of the frequency band to be allocated to each of the plurality of audio signals.

6. The information processing apparatus according to claim 3, wherein a frequency band allocation unit adjusts, in accordance with the degree of importance determined as the condition, the total bandwidth of the frequency band to be allocated to each of the plurality of audio signals.

7. The information processing apparatus according to claim 4, wherein a frequency band allocation unit adjusts, in accordance with the degree of importance determined as the condition, the total bandwidth of the frequency band to be allocated to each of the plurality of audio signals.

8. The information processing apparatus according to claim 1 further comprising:
a localization allocation unit operative to allocate different directions for localization to each of the plurality of audio signals converted by the text-to-sound conversion unit, wherein
the audio processing unit synthesizes, after localizing the plurality of audio signals in the directions allocated by the localization allocation unit, the audio signals.

9. The information processing apparatus according to claim 1 further comprising:
a time allocation unit operative to set the time, at which the plurality of audio signals converted by the text-to-sound conversion unit are output, so as to generate a predetermined lag time, wherein
the audio processing unit synthesizes the plurality of audio signals so that the audio signals are output with the time-lag for the amount of time set by the time allocation unit.

10. An information processing method comprising:
extracting a plurality of character strings from character information under a predetermined condition;
converting a plurality of character strings into respective audio signals;
allocating frequency bands each to the plurality of respective audio signals in a different pattern;
extracting and synthesizing an allocated frequency band component from each of the plurality of audio signals in the pattern of an allocated frequency band; and
outputting a synthesized audio signal as audio.

11. A computer readable medium encoded with a computer program comprising:
a module operative to extract a plurality of character strings from character information under a predetermined condition;
a module operative to convert a plurality of character strings into respective audio signals;
a module operative to allocate frequency bands each to the plurality of respective audio signals in a different pattern;
a module operative to extract and synthesize an allocated frequency band component from each of the plurality of audio signals in the pattern of an allocated frequency band; and
a module operative to output a synthesized audio signal as audio.
